(19) United States
(12) Patent Application Publication
(10) Pub. No.: US 2007/0195416 A1
(43) Pub. Date: Aug. 23, 2007

(54) Interferential Optical Filter

(75) Inventors: Pavel I. Lazarev, London (GB); Serguei P. Palto, Moscow (RU); Michael V. Paukshto, Foster City, CA (US)

Correspondence Address: DORSEY & WHITNEY LLP, 555 CALIFORNIA STREET, SUITE 1000, SUITE 1000, SAN FRANCISCO, CA, 94104, US

(73) Assignee: Nitto Denko Corporation, Osaka (JP)

(21) Appl. No.: 10/567,714

(22) PCT Filed: Aug. 7, 2003
(86) PCT No.: PCT/US03/24733

§ 371 Date: Oct. 3, 2006

(51) Int. Cl. G02B 27/00

(52) U.S. Cl. 359/578

(57) ABSTRACT

An interferential optical filter is provided comprising multiple layers each having real and/or imaginary refraction indexes. The values of the real and imaginary indexes depend on the strength of an external electric field. The material refraction indexes and the thickness of each layer and their combination are selected such as to provide an interference extremum in at least one region of the spectrum, for at least one polarization of incident light. At least one layer is made of an electro-optical material, which is anisotropic and made from at least one aromatic organic material. The molecules or fragments of molecules of the aromatic organic material have a flat structure. At least part of the layer of the electro-optical material has a crystalline structure with an intermolecular spacing of 3.4±0.3 Å along one of optical axes.

### RELATED APPLICATION

This application claims priority to the Russian Patent Application No. 2002-108388, filed Apr. 4, 2002, the disclosure of which is hereby incorporated in its entirety.

### FIELD OF THE INVENTION

The disclosed invention pertains to optical filters and in particular to controllable interferential optical filters.

### BACKGROUND OF THE INVENTION

Optical filters play an important role in many applications. For example, they are widely used in windows, sun glasses and other optical devices, which are used to filter out some light waves such as ultra violet. Optical filters are also widely used in fiber-optic communication devices. For example, such filters are used as band-transmitting filters for blocking noise or pumping signals. Band-transmitting filters are also used for channel selection in multiplexers. Some fiber-optic devices use special optical filters, in order to perform demodulation or splitting light signal into a number of discrete signals. Furthermore, optical filters are used in optical logical schemes in optoelectronic applications. Optical filters are used not only for transmitting optical signals in the operating band of wavelengths, but also for reflecting optical signals in the desired band of wavelengths. For example, optical filters may be formed in such a way that they reflect particular wavelengths of light, for example, in the visible range. Reflecting optical filters are used as blocking filters (to block noise and pumping signals) in fiber-optic communication devices in conjunction with optical amplifiers or optical lasers. Optical filters may be used for creating mirrors. Besides that, they may be utilized in displays.

There is a known interferential optical filter (R. Ditchbern, Physical Optics; R. W. Ditchburn, “Light”, Blackie, & Son Limited, London, Glasgow), which is created in the following manner. Optically transparent substrate is coated with a number of thin layers of transparent materials having different value of refraction index. These layers are known as interferential layers, and by controlling the thickness or refraction index of these layers, one may change the coefficient of transmission of optical signal or, in other words, change filtering properties of the filter. For example, interferential filters are sometimes used in construction for windows. Alternating layers of various transparent materials having different values of refraction index are coated on the surface of the window. The thicknesses and values of the refraction index of the materials are selected in such a way that the filter cuts off light of an undesired wavelength range, for example, ultraviolet light; or in other words, the filter reflects selected wavelengths, i.e. works as a mirror. Although these types of optical filters are effective, they have certain drawbacks. The characteristics of such filters are determined by the composition and thickness of the alternating layers. Moreover, filtering properties of such interferential filters can not be varied after fabrication. Also, these interferential filters can not be used where control over the light filtering process is needed.

There is a known interferential optical filter (M. Born, E. Volf, <<Basics of Optics>>; and Max Born, Emil Wolf, <<Principles of Optics>>, second edition, Pergamon Press, 1964), which comprises two sets of alternating layers of materials having various refraction indexes. Each pair of the alternating layers has a layer with low refraction index and a layer with high refraction index. Such filter is called the standard of Fabry-Perot. In order to tune the standard of Fabry-Perot in the desired range of wavelengths, one can use two sets of layers, which are separated with a special spacer, while layers with high refraction index of each set of layers are situated in front of each other. The necessary distance between these two layers is maintained with high precision by the mentioned spacer, usually made of quartz. The mentioned spacer represents the standard. The gap between the two sets of alternating layers is filled with material having low refraction index. In order to make the standard of Fabry-Perot and adjustable filter, it is necessary that a motion generator is included to move the two sets of alternating layers relative to each other. By increasing or decreasing the distance between the above two sets of layers in the standard of Fabry-Perot, the band of wavelengths which is being filtered can be controlled. Although such adjustable filters are widely used, especially in fiber-optic electronics, these filters possess obvious drawbacks. As we have mentioned above, at least some of these filters use motion generators in order to change the gap between the two sets of alternating layers. Providing precise control over the motion generators and the motion of the moving mechanism is a challenging mechanical problem. Besides that, these motion generators usually have large time constants. It should be noted that motion generators are also usually large relative to the other electrical and/or optical components in the system.

U.S. Pat. No. 4,358,851 describes a known fiber-optic device, comprising a combination of fiber-interferential filter. Such device is used in optical communication systems for selection of signals of certain wavelength or selection of certain range of wavelengths coming from the source of optical radiation. If the source is a semiconductor laser, then the device may also be used for controlling an individual longitudinal mode in the selected wavelength or in the selected range of wavelengths. The known fiber-optic device is intended for use in optical communication systems. The interferential filters are characterized by narrow operating bandwidths and capable of transmitting or reflecting signals in selected wavelengths. The known device comprises a multilayer optical structure, fabricated on the end of an optical fiber. The interferential filter included in the device may be used for transmitting the signal on the selected wavelength from the light source to the optical fiber and reflect all the other wavelengths back to the source. The filter may be designed in such a way that it reflects incident optical signals of all wavelengths. The filter may also operate as partially reflecting filter (rejecting filter) for the optical signal on the selected wavelength, in which case the selected signal is reflected back to the source, while the signals on all the other wavelengths are delivered into the optical communication system. The known optical device is intended for reflecting or transmitting optical radiation of a semiconductor laser such as GaAs/GaAlAs injection laser. The operational bandwidth of the interferential filter is within the limits of the working wavelengths of the laser, so that the filter transmits optical signals on at least one selected wavelength within the range of the optical radiation of the laser. In this case, the reflected signals on the rest of the wavelengths provide optical feedback to the laser. The known optical filter may be used for transmission of optical signals on the desired wavelength from the semiconductor laser, as well as for transmission of laser radiation in a narrow bandwidth. The known optical filter may be used in an optical device comprising a source of coherent or incoherent radiation, the output signal of which is incident on the system of several optical fibers. On the cleaved end of each of those fibers there is an interferential optical filter, intended for transmitting light signal on a certain wavelength. Therefore, each fiber guides a signal from the source on its own wavelength. Such device allows extracting optical signals of various colors from multi-frequency signal source. The drawback of this optical device is that it is impossible to control its optical characteristics.

U.S. Pat. No. 5,434,943 describes a known controllable optical filter. This adjustable optical filter comprises a wave guiding layer, situated on a substrate between a first contact layer and a second contact layer. Adjustment of the optical filter is performed by passing current through it, which in turn injects mobile charge carriers into the layer of the waveguide. Injected charge carriers change refraction index of the waveguide material. While this adjustable optical filter has advantages compared to the reconfigurable standard of Fabry-Perot since it does not use motion generators for tuning, it has some drawbacks as well. This adjustable optical filter requires relatively high current density in order to stimulate injection of charge carriers into the region of the waveguide. This requirement of high current density limits the size and shape of filters that can be manufactured. The larger the size of the filter, the higher the current it requires to operate.

There is known optical filter based on multilayer structure comprising optically anisotropic layers (see N. P. Gvozdeva et. al., Physical Optics. M.: Maschinostroenie, 1991). Such filters are, interferentially-polarizing (IFP) light filters, operation of which is based on interference of polarized light rays. The distinct feature of such filters is the possibility of selecting very narrow spectral bands (up to 10⁻² nm) without any background noise. Often times to fabricate individual layers of IFP-light filters, one uses thin plates of various crystals, for example, crystalline quartz or Iceland spar. Drawbacks of such filters include the difficulty of their fabrication and tuning.

U.S. Pat. No. 5,037,180 describes a known optical filter, which is fabricated on the cleaved end of an optical fiber. Such filter consists of a multilayer thin-film structure, within which layers of materials with low and high refraction index are alternating. Such fiber-optic filter is for long wavelengths, standard of Fabry-Perot and others. The filter placed on the cleaved end of a single-mode fiber, which is perpendicular to the axis of the fiber, reflects the larger portion of the incident power back to the source of the optical signal. Reflected power travels back to the exit of the laser or optical amplifier and leads to spontaneous excitation of the optical device. Therefore, one of the variants of this optical filter is the multilayer thin-film optical structure, created on the slanted butt-end surface of the fiber. In this case, the reflected power does not go back to the source of optical radiation, but is led away from the optical fiber. The drawback of such optical filter is that it is impossible to adjust its characteristics, such as, for example, the band of wavelengths, within which it transmits, rejects or reflects optical signals.

U.S. Pat. No. 3,610,729 describes a known multilayer polarizer, the operation of which is based on interference of light in the multilayer optical structures. The known polarizer belongs to the class of polarizers, at the exit of which the transmitted light appears polarized, and the light reflected from such polarizer also appears polarized. Moreover, polarization of the transmitted light and polarization of the reflected light are mutually orthogonal. The majority of reflecting types of polarizers are quite difficult to produce, they are bulky and costly and seldom used for polarizing visible light. There is a great need for a polarizer that can effectively and linearly polarize and transmit the greater portion of the incident light, while reflecting the orthogonally polarized light. In order to achieve such properties, the known polarizer represents a multilayer optical structure. Layers may be fabricated in sequence from birefringent and isotropic materials, while one of the two refraction indexes of the birefringent material is approximately equal to the refraction index of the isotropic material of the adjacent layer. In another variant of the known polarizer, layers may be sequentially fabricated from two different birefringent materials. In this case, the lower of the two refraction indexes of one of the materials is approximately equal to the higher refraction index of the other material.

When light, within certain band of wavelengths is incident on the polarizer, it is split by the polarizer into two light rays. The first light ray passes through the alternating layers of the polarizer and becomes linearly polarized. The other light ray is reflected from the polarizer and becomes also linearly polarized and its polarization is orthogonal to the polarization of the first (transmitted) light ray. The mentioned layers have thickness equal to quarter wavelength of the incident light. In this case coefficients of reflection and transmission of the polarized rays assume maximum values, approaching 50% of the incident light.

Therefore, this known device—multilayer polarizer—simultaneously represents reflecting filter for one polarization of light and transmitting filter for the other.

One of the possible methods of fabrication of thin layers is vacuum deposition, which allows performing precise control over the thickness of layers almost on the molecular level. Another method of fabricating the multilayer polarizer is performed using combination of extrusion and stretching. This has an orienting effect on the birefringent polymer films. The number of alternating layers necessary to achieve the required characteristics of the polarizer depends greatly on the values of the refraction indexes of the utilized materials. Enhancing characteristics of the polarizer may be possible by using a large number of alternating layers in the structure of the polarizer. Generally, the larger the number of alternating layers, the better. However, the vacuum deposition process limits the number of layers possible to incorporate into the polarizer, since this process is quite complex and takes a long time. The process of vacuum deposition of multilayer structures is mechanically unstable because the individual layers usually exist in highly energized state as a result of the deposition, and therefore additionally scatter light. The process of combined extrusion overcomes these difficulties. This process allows fabricating polarizers with a large number of very thin alternating layers. Moreover, this process allows fabricating layers out of two or more materials in a single continuous process, wherein structural instabilities, mechanical stresses and light scattering are insignificant. Various materials can be used as the birefringent materials in the known polarizer. For example, the material may consist of a mixture of nine parts of terephthalic acid and one part of isophthalic acid. It has been found that this material has two refraction indexes of 1.436 and 1.706. Additionally, one may use such birefringent polymer materials as styrofoam, plexiglas, polysulphone and terephthalate polyethylene. Other materials may also be used to create birefringent layers and can be optimized to have the largest possible difference between the two refraction indexes. The fact is that the number of layers in a polarizer may be significantly decreased by using birefringent materials with large difference between the refraction indexes. Isotropic layers may be fabricated out of a multitude of various materials with the condition that their refraction indexes are approximately equal to one of the refraction indexes of the birefringent materials used in layers on both sides of the isotropic layer. Materials which are useful for this purpose include fluorinated polymers, magnesium fluoride and acetobutyrate of cellulose. Isotropic layers may also be fabricated using vacuum deposition in such a way that their thickness may be precisely controlled. Isotropic layers may be fabricated using extrusion and simultaneous fabrication of the birefringent layers.

The drawback of this interferential optical device is that it is impossible to adjust its optical characteristics, such as the transmission or reflection bands.

WO 00/45202 describes a known adjustable interferential optical filter, which contains two sets of alternating dielectric layers, fabricated on the top of each other and made out of two different dielectric materials. The first and second dielectric materials have different refraction indexes. The known optical filter also comprises an intermediate layer situated between the first and the second sets of the alternating layers. It is important that the material of the intermediate layer has refraction index, which changes depending on the value of the applied electric field. Furthermore, the first set of the alternating layers is placed on the substrate made of optically transparent material. Such adjustable interferential optical filter does not have many of the above mentioned drawbacks inherent to the above listed optical filters. In particular, this optical filter, as has been noted above, contains an intermediate layer of a material that has variable refraction index depending on the value of the applied electric field. By varying the electric field, the operation of this optical filter can be controlled in order to provide transmission or reflection of the incident light in the desired range of wavelengths. Since the refraction index of the intermediate layer may be controlled by the electric field, the optical characteristics of the filter may be adjusted without changing the thickness of the alternating layers or without mechanical translation of individual parts of the filter. Therefore, the characteristics of the optical filter may be more easily changed, while the time constant of the system is significantly decreased. Moreover, since refraction index may be changed due to changes in electric field applied across the intermediate layer, such optical filter may be fabricated in a variety of shapes and may be made in large or small size.

One of the drawbacks of this known interferential optical filter is that it is necessary to use a large number of alternating layers. Therefore, in order to obtain a large value of the reflection coefficient, as many as 100-600 layers have to be deposited, deposition of which poses a challenging technical problem and requires special precision equipment.

### SUMMARY OF THE INVENTION

The present invention provides an adjustable interferential optical filter that overcomes the drawbacks of the prior art optical filters, such as technical difficulties of fabrication and control over parameters of the adjustable interferential optical filter, the necessity to use a large number of alternating dielectric layers; high sensitivity of adjustable interferential optical filters to temperatures; and high energy consumption necessary to control interferential optical filters.

The adjustable interferential optical filter of the present invention uses significantly less number of alternating layers and significantly lower operational voltage; filters polarized as well as non-polarized optical waves; is controllable by voltage; can operate at elevated temperatures; and cost effective in fabrication. The thickness of the electro-optical anisotropic thin crystal film can be controlled through the content of the sold phase in the liquid crystal and the thickness of the “wet layer” during its application. The electro-optical effect can be obtained without passing current through the layer of the electro-optical material. The interferential optical filter can be made compact based on optical fibers for fiber-optic communication systems; and the absorption, reflection or transmission bands of the controllable interferential optical filter can be controlled by applying an external electric field.

The interferential optical filter of the invention comprises multiple layers each having real and/or imaginary refraction indexes. The values of the real and imaginary indexes depend on the strength of an external electric field. The material refraction indexes and the thickness of each layer and their combination are selected such as to provide an interference extremum in at least one region of the spectrum, for at least one polarization of incident light. At least one layer is made of an electro-optical material, which is anisotropic and made from at least one aromatic organic material. The molecules or fragments of the molecules of the aromatic organic material have a flat structure. At least part of the layer of the electro-optical material has a crystalline structure with an intermolecular spacing of 3.4±0.3 Å along one of optical axes.

### BRIEF DESCRIPTION OF THE DRAWINGS

The invention will be more clearly understood from the following description when read in conjunction with the accompanying drawings in which:

FIG. 1 shows a typical diffraction of x-ray radiation in the thin crystal films fabricated based on blue dye.

FIG. 2 is a schematic showing a layered crystalline structure of a thin crystal film.

FIG. 3 is a schematic showing an interferential optical filter comprising a layer of a conducting transparent material.

FIG. 4 is a schematic showing an interferential optical filter comprising two layers of a conducting non-transparent material.

FIG. 5 is a schematic showing an interferential optical filter comprising conducting layers formed on the side surfaces of the multilayer optical structure.

FIG. 6 is a schematic showing an interferential optical filter comprising two alternating multilayer optical structures, and a layer of conducting material formed on the surface of an intermediate layer.

FIG. 7 is a schematic showing an interferential optical filter comprising two alternating multilayer optical structures, and a layer of conducting material formed on the substrate.

FIG. 8 is a schematic showing an interferential optical filter comprising a core and cladding, inside of which there are layers of the interferential optical filter which comprises two conducting layers and alternating layers of multilayer optical structure.

FIG. 9 is a schematic showing an interferential optical filter with slanted alternating layers.

FIGS. 10 to 15 are schematics showing different designs of the controllable interferential optical filters comprising a core and cladding, inside of which there are two multilayer optical structures of alternating layers of low and high refraction indices and two conducting layers.

FIG. 16 is a schematic showing an interferential optical filter comprising a core and cladding, inside of which there are layers of the interferential optical filter which comprises two conducting layers and alternating layers of multilayer optical structure.

FIG. 17 is a schematic showing an interferential optical filter with slanted butt-end of the optical fiber.

FIG. 18 is a cross-sectional view of an interferential optical filter, on the cladding of which there are two cylindrical layers of multilayer optical structure and two cylindrical layers of transparent conducting material, wherein the intermediate layer with low refraction index is between two multilayer structures, and the low-high refraction index layers of the multilayer structures have a predetermined sequence.

FIG. 19 is a cross-sectional view of an interferential optical filter, comprising a D-shaped optical fiber, wherein on the flat surface of the cladding there are two layers of multilayer optical structure and two cylindrical layers of transparent conducting material, wherein the intermediate layer with low refraction index is between two multilayer structures, and the low-high refraction index layers of multilayer structures have a predetermined sequence.

FIG. 20 is a schematic showing an optical device comprising an optical fiber with a core and cladding and controllable interferential filters, wherein between the optical fiber and the filter there is a microlens.

FIG. 21 is a schematic showing a fiberoptic device, which comprises a segment of an optical fiber with a core and cladding and two controllable interferential filters created on the opposite butt-ends of the optical fiber segment.

FIG. 22 is a schematic showing a device which allows extracting signals of various colors out of a multi-wavelength source; the light source may generate coherent or incoherent light, and a controllable interferential filter is positioned on the butt-end of each fiber.

FIG. 23 is a schematic showing an optical filter comprising a grating in the core of a fiber.

FIG. 24 is a schematic showing an optical filter comprising two gratings in the core of an optical fiber, an active multilayer system of alternating layers, and electrodes on the outside of the cladding.

FIG. 25 is a schematic showing a controllable electrooptical device which represents a combination of the devices illustrated in FIGS. 23 and 24.

FIGS. 26 and 27 illustrate the spectral characteristics of the reflection coefficient of a multilayer system in accordance with one embodiment of the invention.

FIGS. 28 and 29 illustrate transmission and reflection coefficients of a multilayer system in accordance with the embodiments of the present invention.

FIGS. 30 and 31 illustrate the spectral characteristics of a multilayer system in accordance with the embodiments of the invention.

### DETAILED DESCRIPTION OF THE INVENTION

The present invention provides an interferential optical filter that comprises at least one layer of an electro-optical material, which is anisotropic and fabricated from at least one aromatic organic material, molecules or fragments of molecules of which have a flat structure, and at least a part of the mentioned layer has a crystalline structure with an intermolecular spacing of (Bragg peak) 3.4±0.3 Å along the optical axes, and at least one of the anisotropic refraction indexes and/or absorption coefficients of which change depending on the value of the electric field. The material of such a layer will be further called optically anisotropic thin crystal film.

In one embodiment, the interferential optical filter comprises at least one layer of an anisotropic electro-optical material, which is treated with ions of two- and three-valence metals. In another embodiment, the molecules of at least one aromatic organic material contain heterocycles. The interferential optical filter can contain at least one layer of anisotropic electro-optical material, which is made of lyotropic liquid crystal based on at least one dichroic dye.

The unique optical properties of the electro-optical anisotropic thin crystal film (small thickness, low temperature sensitivity, high anisotropy of refraction indexes, anisotropy of absorption coefficients, large value of dichroic ratio and simplicity of fabrication) are due to the special features of the material and the method of fabricating used to make the thin crystal film, in particular the molecular-crystalline structure of the thin crystal film, which is fabricated via crystallization of the liquid-crystal phase of at least one organic material, which forms lyotropic or thermotropic liquid crystal phase, via application of the liquid crystal onto a substrate using aligning influence and subsequent drying. In the capacity of the organic material, the disclosed electro-optical anisotropic thin crystal film uses at least one organic material, the formula of which contains at least one ionogenic group, which provides its solubility in polar solvents and/or at least one non-ionogenic group, which provides its solubility in non-polar solvents and/or at least one anti-ion, which in the process of obtaining the material may or may not remain in the structure of the molecule.

The electro-optical anisotropic thin crystal film is created by the multitude of supramolecular complexes (Jean-Marie Lehn, <<Supramolecular Chemistry Concepts and Perspectives>>,—Weinheim; New York; Basel; Cambridge; Tokyo: VCH Verlagsgesellschaft mbH, 1995) of one or several organic materials. Moreover, the supramolecular complexes are aligned in a certain way to provide its electrical conductivity and polarization of the passing light.

The initial choice of material to fabricate the electro-optical anisotropic thin crystal film is determined by the presence of r-conjugate bonds in the aromatic conjugate cycles and the presence in molecules groups like amine, phenol, ketone, etc. laying in the plane of those molecules and representing a part of the aromatic system of bonds. The molecules themselves or their fragments have flat structure. For example, these can be such organic materials as indanthrone (Vat Blue 4), or dibenzoimidazole 1,4,5,8-perelenetetracarboxilic acid (Vat Red 14), or dibenzoimidazole 4,9,10-perelenetetracarboxilic acid, or quinacridone (Pigment Violet 19) and others, derivatives of which or their mixtures form stable lyotropic liquid crystal phase.

When the organic compound is dissolved in a suitable solvent, it forms a colloid system (lyotropic liquid crystal (LLC)), where molecules are joined into supramolecular complexes, which represent kinetic units of the system (Patent application RU2000104475 Feb. 25, 2000). The liquid crystal phase represents the preordered state of the system, from which, in the process of alignment of the supramolecules and subsequent removal of the solvent, there appears solid electro-optical anisotropic thin crystal film (or in other words electro-optical anisotropic crystalline film).

The method of obtaining thin electro-optical anisotropic thin crystal films from a colloid system with supramolecules comprises the following steps:
applying the above-described colloid system onto the substrate (or a ware, or one of the layers in the multilayer structure); the colloid system should also be thixotropic (Robert J. Hunter <<Foundations of Colloid Science v. 1, Clarendon Press. Oxford, 1995, p. 88), for which the colloid system should exist at certain temperature and have certain concentration of the dispersion phase;
bringing the applied or applying colloid system into the state of elevated fluidity via any kind of external impact, which decreases the viscosity of the system (this can be heating, shear deformation, etc.); the external impact may continue during the entire next process of alignment or last for a period necessary to prevent relaxation of the system into the state of higher viscosity during the time of alignment;
externally aligning impact on the system, which may be performed by mechanical as well as any other methods, for example external electrical field (for example, poling at the normal or high temperature with or without the simultaneous illumination), or magnetic field, or optical radiation field (for example, due to coherent photovoltaic effect); the degree of the mentioned impact should be sufficient in order for the kinetic units of the colloid system to obtain the necessary alignment and form structure that will represent the foundation of the future crystalline lattice of the emergent electro-optical anisotropic thin crystal film;
converting the oriented region of the emergent layer from the state with lowered viscosity, which is achieved through initial external impact on the system, into the state with the original or even higher viscosity of the system; this is performed in such a way as to avoid disorientation of the structure of the emergent electro-optical anisotropic thin crystal film and prevent formation of defects on its surface; and
drying to remove the solvent, during the process of which the crystalline structure of the electro-optical anisotropic thin crystal film is created.

In the obtained electro-optical thin crystal film, the planes of molecules are parallel to each other and molecules form three-dimensional crystal in at least a part of the thin crystal film. By optimizing the fabrication procedure, a mono-crystalline electro-optical anisotropic thin crystal film can be obtained. The optical axis in this thin crystal film is perpendicular to the planes of molecules. Such thin crystal film possesses high degree of anisotropy, and for at least one direction, high refraction index and/or absorption coefficient.

The optical anisotropy of the electro-optical anisotropic thin crystal film is described by ellipsoids of the imaginary and the real parts of the complex refraction index, characterized by the angular dependence of the absorption coefficient and refraction index accordingly (the imaginary and real parts of the complex anisotropic refraction index). For the components of the imaginary (Kᵢ) and real (nᵢ) parts of the complex refraction index of the optically anisotropic thin crystal film, according to the invention, the following correlations should simultaneously be true:
K₁≧K₂>K₃,
(n₁+n₂)/2>n₃,

where K₁, K₂, K₃ and n₁, n₂, n₃ are the main values of the axes of the ellipsoid of, correspondingly, the imaginary and real parts of the anisotropic complex refraction index of the thin crystal film material.

The components of the real and imaginary parts of the anisotropic complex refraction index, as well as the direction of the axes of the ellipsoid may be experimentally determined via existing ellipsometric or spectrophotometric methods.

Providing the necessary anisotropy of the absorption coefficients (K₁, K₂, K₃) and refraction indexes (n₁, n₂, n₃), as well as the orientation of the major axes, i.e. optical properties of the electro-optical anisotropic thin crystal film in the multilayer structure, is possible via imposing certain angular distribution of molecules in the polarizing film on the surface of the substrate.

It is also possible to mix colloid systems (in which case combined supramolecules will form in the solution) to obtain thin crystal films with intermediate optical properties. Absorption and refraction of electro-optical anisotropic thin crystal films obtained from mixtures of colloid systems may assume various values within the limits determined by the original components. Mixing various colloid systems to obtain combined supramolecules is possible due to the coincidence of one of the dimensions of molecules (intermolecular spacing) of various organic compounds (3.4±0.3 Å).

The control over the thickness of the electro-optical anisotropic thin crystal film is performed through the content of solid matter in the solution being applied. The process variable in fabrication of these electro-optical anisotropic thin crystal films is the concentration of the solution, which is conveniently controlled during the fabrication.

The degree of crystallinity of the thin crystal film may be controlled through crystallography and/or optical methods.

Such method of fabrication of anisotropic thin crystal films allows using various materials such as semiconductors, dielectrics, crystals, polycrystals, glasses, polymers and other materials in the capacity of the substrate material. Moreover, the mentioned method allows fabricating electro-optical thin crystal films on various surfaces, including of complex shapes (flat, cylindrical, conical, spherical and others), which allows using these thin crystal films in the most difficult configurations of controllable interferential optical filters, in particular on the butt-ends and sides of optical waveguides, on flat polished side planes of such waveguides, as well as on the external and internal surfaces of photon-crystalline fiber waveguides (i.e. light guides, containing a system of longitudinal air channels in the core and/or reflecting cladding).

The surfaces, which are coated with thin crystal films, may undergo additional processing to provide uniform wettability of the surface to provide hydrophily of the surface. This may be mechanical processing, annealing, mechano-chemical processing. Prior to application of the thin crystal film on the surface of the substrate, aligning anisotropic structures may be formed by mechanical processing of the substrate surface, which promotes higher degree of orderliness of molecules in the thin crystal film.

The possibility of using significantly lower operating voltages is achieved due to the fact that anisotropic thin crystal films have a small thickness (on the order of 100-800 nm), and since electrostatic intensity is determined by the voltage applied to the sample (U) and its thickness (D) through the following formula: E=U/D.

The possibility to create active devices for filtering polarized and non-polarized optical waves (wherein polarized optical waves are controlled), is achieved due to the fact the material features electrical and optical anisotropy with high degree of birefringence so that the utilized thin crystal film having a thickness of 0.3 μM has maximum value of the retardation (nₒ−nₑ) d=0.24, which, in the case of using traditional materials, is achieved with a thickness of 200 μm (Lazarev, P. and Paukshto, M., “Thin Crystal Film Retarders” (2000). Proc. of the 7^{th} International Display Workshops, Materials and Components, Kobe, Japan, November 29-December 1, 1159-1160). The refraction index of the thin crystal film may significantly differ from the refraction index of quartz glass, and depends on the strength of the applied external electric field. Besides that, the material under consideration is photosensitive, i.e., its optical characteristics change under the influence of laser radiation. This material is also interesting because of its non-linear optical properties, since its refraction index depends on intensity of optical radiation.

The low sensitivity of the disclosed controllable optical device to temperature changes is achieved due to the fact that utilized crystalline film features high thermal stability compared to the traditional materials: it can be processed at temperatures of up to 180° C. in air and in argon for four hours, while the polarizing efficiency drops no more than 0.8%.

The high manufacturability is achieved due to the fact that the thin crystal film material is easily applied on surfaces of any profile, it is easy to adapt it for fabrication and it is economical.

The high manufacturability of thin crystal films, as well as simplicity of control of its parameters, make using electro-optical anisotropic thin crystal films promising in controllable interferential optical filters for fiber-optic communication systems. Thus, thin crystal films allow creating miniature fiber-optic filters, since it appears to be easy to apply such thin crystal films of small sizes on surfaces of complex profiles including side and/or butt-end surfaces of optical fibers. Optical fibers have very small dimensions. Thus, the core of a single-mode fiber has diameter from 5 to 10 μm, and diameter of the reflecting cladding is 125 μm.

Optical fibers may differ by materials from which they are fabricated, in particular, there are optical fibers based on quartz glass, chalcogenide and fluoride glasses, thallium halogenides and other inorganic or organic crystalline and non-crystalline optical materials, and in particular polymers, or combinations of such materials.

There are three basic types of optical fibers: glass fibers which have a glass core and glass cladding, fibers which have a glass core and plastic cladding, and plastic fibers which have a plastic core and plastic cladding.

In fiber light guides, the core and/or one or several claddings may be based on any material, such as quartz glass, fluoride glass, chalcogenide glass, polycrystalline light guides based on halogenides, polymers.

All listed materials can be coated with small-size electro-optical anisotropic thin crystal films with characteristic size from tens to hundreds of micron. Moreover, the list of materials, surfaces of which can be coated with thin crystal films is not limited by those mentioned above.

The fabrication of controllable interferential optical filters is related to the necessity of fabricating electro-optical materials on complex geometrical surfaces.

The disclosed method of fabricating thin crystal film allows placing it on flat as well as complex surfaces of second and higher orders (for example, cylindrical, spherical, conical, etc.). Therefore, this method allows creating thin crystal films on the cylindrical surface of cladding of the optical fiber, on the flat surface of its cleaved butt-end, on the flat polished surface of the cladding of D-shaped fiber (bent light guide with a flat polished surface, a portion of which is situated close to the core of the fiber or the light guide drawn with cross section in the shape of letter “D” with the core close to the flat surface).

The present method allows creating thin crystal films on the surface of the cladding of an optical fiber, within the core of which there is at least one long-range grating. The grating may be fabricated by any method (for example, with radiation or doping of the optical fiber), and it promotes stronger interaction of the optical signal with the interferential optical filter, created, for example on the cladding.

The application of the anisotropic thin crystal film in the controllable interferential optical filters is based on the fact that the anisotropic refraction indexes and absorption coefficients of this material depend on the strength of the applied electric field, the thickness of the film depends on the applied electric field (electrostriction), and the refraction index depends on the electric field of the optical radiation. The film represents the external coating of the fibrous or planar optical waveguide, which interacts with the part of the mode of the waveguide, which penetrates into the electro-optical membranous coating from the wave guiding layers of the optical waveguide.

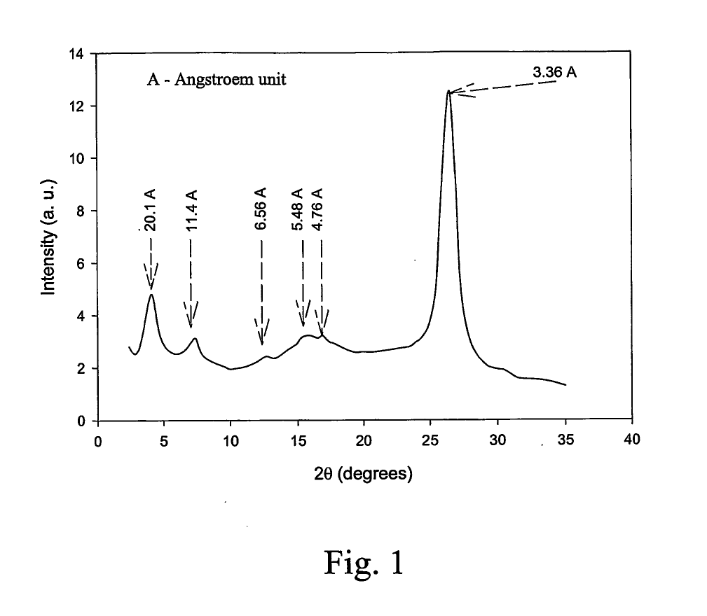

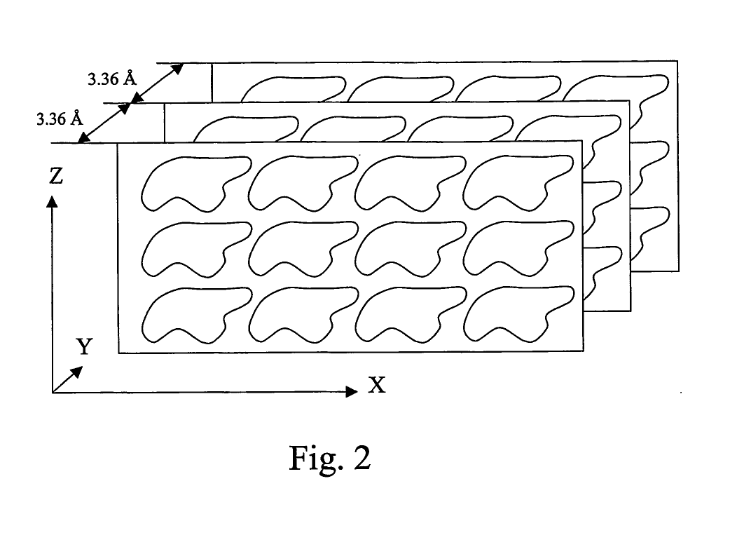

FIG. 1 illustrates a typical diffraction of x-ray radiation in the thin crystal films fabricated based on blue dye. The coordinate of the largest intensity peak in a rontgenogram of such crystalline film (3.36 Å) is the same as for lyotropic liquid crystal materials. Taking the structure of lyotropic liquid crystal materials into account, wherein rod-like aggregates (stacks) are formed by the flat cyclical molecules of the dye, it is assumed that such π-π conjugation of aromatic molecules is preserved during the formation of thin crystal films. It has been determined that the thin crystal film represents a polycrystalline material with layered crystalline structure as shown in FIG. 2, where the distance between the layers is approximately equal to the “thickness” of the molecule (3.36 Å). Molecules of the dye are distributed inside of the layers so that every next layer has certain orientation relative to the previous one. It has been also found that mechanical impact disturbs the micro-structure of the crystalline block. The thin crystal films have certain dominating crystalline orientation, while maximum divergence of crystallites is within 10°-25°. The order parameter, determined by the analysis of the texture and optical data approximately equals 0.9.

In one embodiment, the interferential optical filter comprises at least one layer of anisotropic electro-optical material which is treated with ions of two- and three-valence metals. In another embodiment, the molecules of at least one aromatic organic material contain heterocycles. The interferential optical filter can contain at least one layer of an anisotropic electro-optical material, which is made of lyotropic liquid based on at least one dichroic dye.

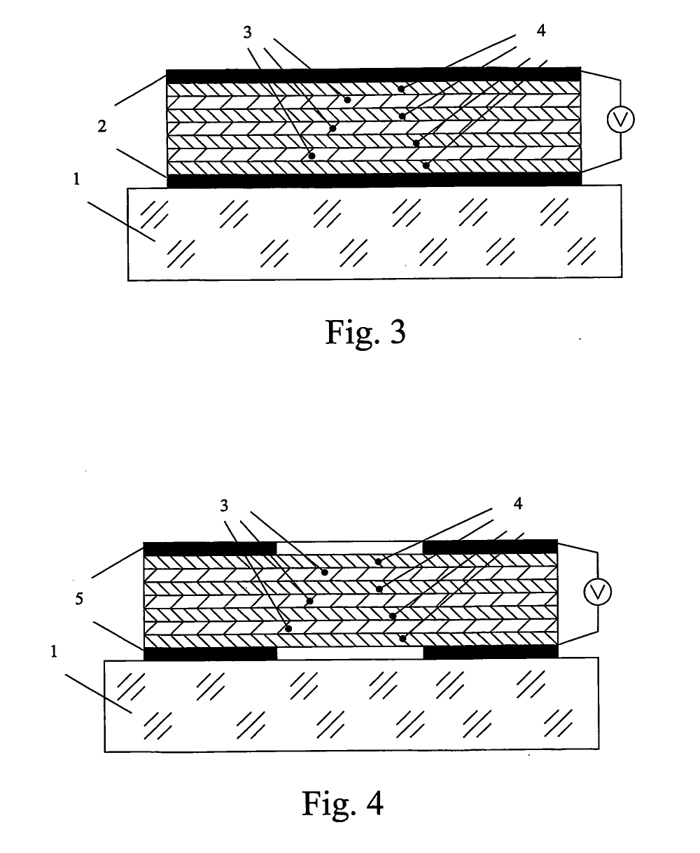

FIG. 3 presents an interferential optical filter, comprising substrate 1, which is coated with a layer of conducting transparent material 2, which is covered with other layers of an interferential filter, which in turn represent a multilayer optical structure, comprising alternating layers with low n_{L} 3 and high n_{H} 4 refraction indexes. Above the multilayer structure there is a second layer of transparent conducting material 2. The thicknesses of the alternating layers are chosen with the condition that L==m*λ/(4*n), where, m represents an odd integer, λ represents the operating wavelength of the filter, and n represents the corresponding refraction index (n_{L} or n_{H}). As indicated in the literature (see Max Born, Emil Wolf, <<Principles of Optics>>, second edition, Pergamon Press, 1964), the reflection coefficient of such multilayer structure increases with the increase of the ratio n_{H}/n_{L} and the number of pairs of layers with low and high refraction indexes. The filter represented in FIG. 3 operates in the following manner. A control voltage V is applied to the conducting layers 2, as a result of which electric field is established in the multilayer optical structure. The applied electric field has an effect of changing refraction indexes of the alternating layers in the structure. As a result of this change, the operating wavelength of the filter, for which this optical filter features maximum reflection coefficient, is changed. The substrate may be made of optically transparent or non transparent material; this can be a metal, semiconductor, dielectric, in particular, glass, quartz, plastic. The transparent conducting electrodes may be made of tin dioxide (SnO₂) or indium oxide (In₂O₃). Layers of SnO₂ with resistance of 300 Ohm per cm² or less are obtained by pyrolysis of SnCl₄ or hydrate of SnCl₂ in muffle furnace at 400-500° C. This method may be used to create electrodes on a substrate (prior to deposition of the anisotropic thin crystal film). This method may be used to obtain layers of various thicknesses depending on the most important criterion: optical transparency or electrical resistance. Thin wires may be soldered to the SnO₂ layers, using glues such as BF-2 or BF-4 very diluted in ethanol as admixtures. Layers of indium oxide are obtained via cathode evaporation of indium in vacuum of 10⁻⁵ Torr. This method is more manufacturable, and coating properties (mechanical strength, optical transmission, electrical resistance) are approximately the same as for SnO₂. If the conducting transparent coating is deposited onto an organic glass or a semiconductor, then layers of Cu₂S may be used. Finally, the electrodes are connected to the power source, which provides either constant and/or alternating voltage.

FIG. 4 presents an interfereritial optical filter, comprising substrate 1, which is coated with a layer of conducting, non-transparent material 5, above which there are other layers of an interferential filter, which represent a multilayer optical structure, comprising alternating layers with low n_{L} 3 and high n_{H} 4 refraction index. On the top of the multilayer structure there is a second layer of conducting, non-transparent material 5. The thicknesses of the alternating layers are chosen with the same condition as described above in connection with FIG. 3. The layer of conducting, non-transparent material 5 may be deposited onto the surface of the multilayer optical structure via vacuum evaporation of a metal, for example, aluminum. Other metals can be used to create the conducting, non-transparent layers such as gold and titanium, etc. The conducting, non-transparent layer should feature openings to allow transmission of light signal into the structure. These openings may be created by, for example, using a mask during vacuum evaporation or other methods. The principle of operation of the filter is analogous to the case presented in FIG. 3.

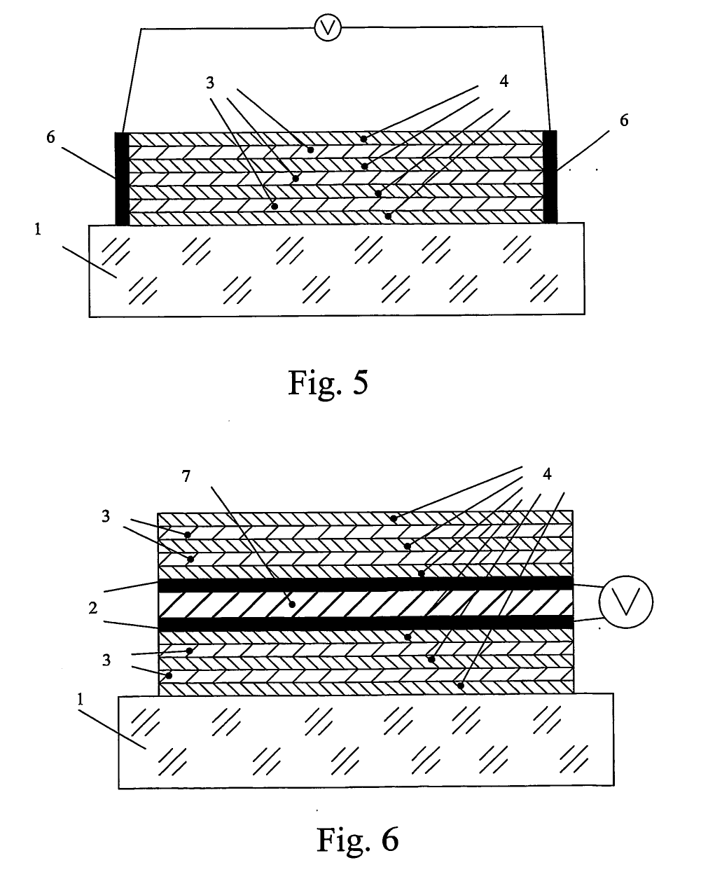

FIG. 5 presents an interferential optical filter, distinct from the ones as shown in FIGS. 3 and 4 by the fact that the conducting layers are formed on the side faces of the multilayer optical structure.

FIG. 6 presents an interferential optical filter comprising substrate 1, which is covered by a first multilayer optical structure of alternating layers with low n_{L} 3 and high n_{H} 4 refraction indexes. Above the first multilayer structure there is a layer of conducting, optically transparent material 2, on top of which there is a layer of material with low refraction index 7. The latter is coated with a second layer of conducting transparent material 2 and a second multilayer optical structure of alternating layers of materials with low and high refraction indexes. The thicknesses of the alternating layers satisfy the same correlations that are satisfied in the examples presented in FIGS. 3-5. The thickness of layer 7 is chosen with the condition that L=m*λ/(2*n), where m represents an even integer, λ represents the operating wavelength of the filter, and n represents the refraction index of layer 7. The thicknesses of layers in such a filter are chosen with the condition to provide maximum transmission coefficient for the working wavelength of the filter. Therefore, such filter represents a band-transmitting filter. The applied control voltage creates an electric field in layer 7, which in effect changes its refraction index. As a result of this change of the refraction index, the transmission band of the filter shifts. The larger the number of half-waves can fit in the thickness of layer 7, the ratio n_{H}/n_{L} in the alternating layers and the number of pairs of alternating layers in the multilayer structures, the sharper the cut-off of the band-transmitting filter.

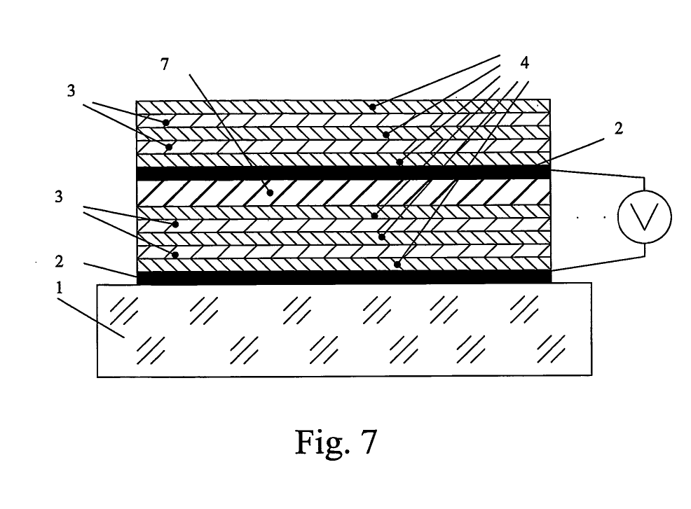

FIG. 7 presents an interferential optical filter, distinct from the one as shown in FIG. 6 by the fact that one layer of conducting material is created not on the surface of the intermediate layer 7, but on the surface of the substrate. In general, the layers of conducting materials may be placed arbitrarily. It is essential that the electric field created between them permeates the layers of the electro-optical materials in the filter, changing their refraction indexes and controlling optical characteristics of the filter.

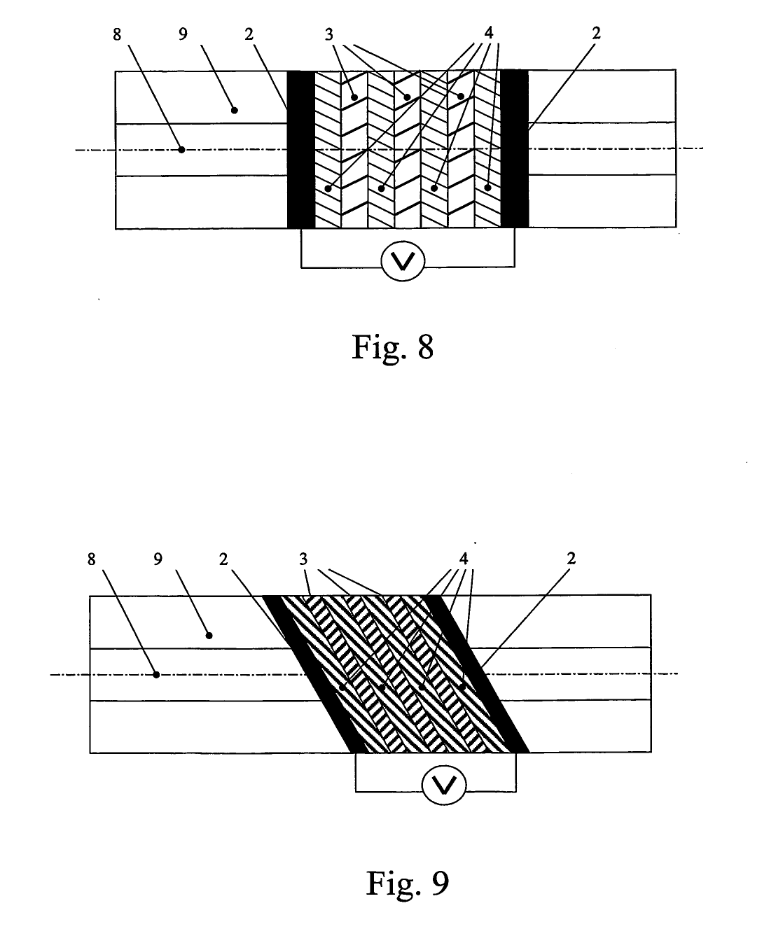

FIG. 8 presents an interferential optical filter, comprising an optical fiber having core 8 and cladding 9, in which there are layers of an interferential optical filter, which represent a multilayer optical structure of alternating layers with low 3 and high 4 refraction index. On both sides of the multilayer optical structure, there is a layer of electrically conducting material 2. The control voltage is applied to these two conducting layers. The thicknesses of the alternating layers satisfy the following correlation L=m*λ/(4*n), where m represents an odd integer, λ represents the operating wavelength of the filter, and n represents the corresponding refraction index (n_{L} or n_{H}). Such filter features maximum reflection coefficient for the operating wavelength. The applied voltage onsets electric field within the alternating layers, as a result of which refraction indexes of the individual alternating layers change, and therefore the operating wavelength for the filter featuring maximum reflection coefficient changes as well.

FIG. 9 presents an interferential optical filter, comprising an optical fiber having core 8 and cladding 9, inside of which there are layers of an interferential filter, which represent a multilayer optical structure of alternating layers with low 3 and high 4 refraction index. The difference from the one as shown in FIG. 8 is that the alternating layers are slanted (i.e. the direction of the normal to these layers makes an acute angle from 0 to 90° with the axis of the optical fiber). In this case, the reflected wave is directed out of the optical fiber. Such filter may be used at the output aperture of a laser or optical amplifier. Since the reflected wave does not return to the source of optical signal, such filter increases stability of optical systems against spontaneous excitation.

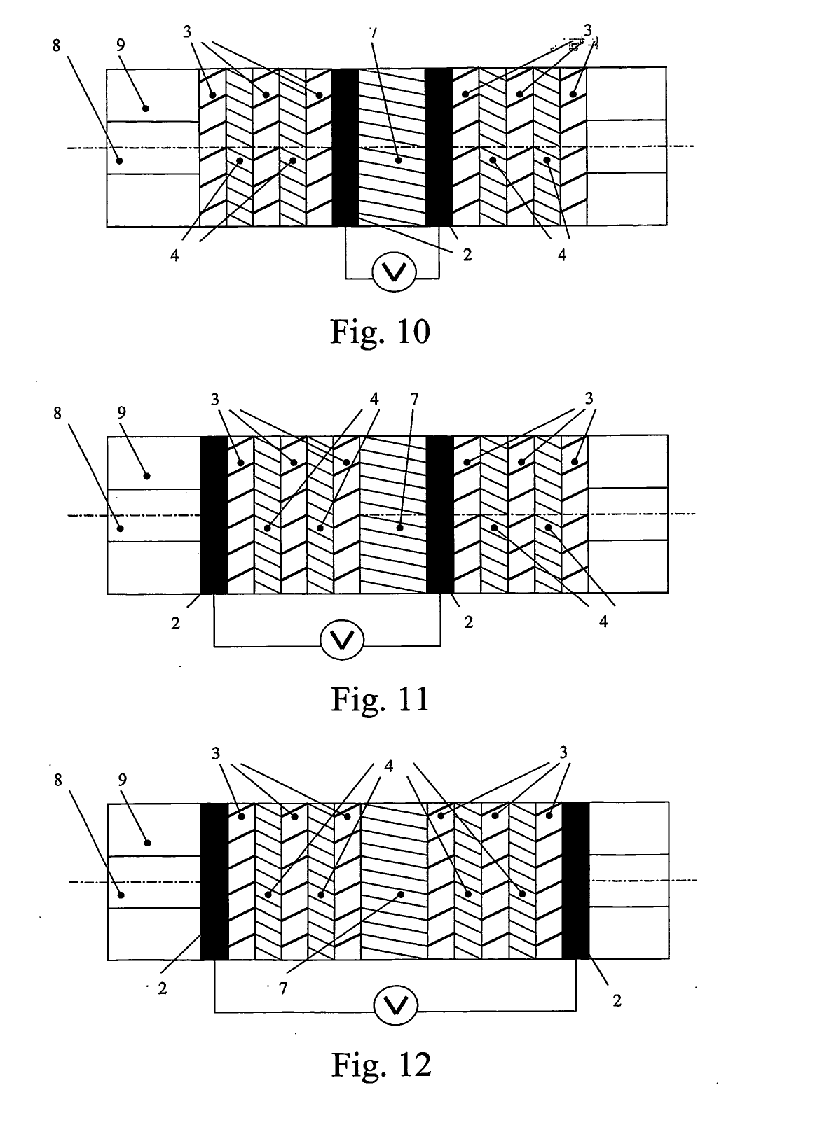

FIG. 10 presents a controllable interferential optical filter, comprising an optical fiber having core 8 and cladding 9, inside of which there is a first multilayer optical structure of alternating layers with low 3 and high 4 refraction index. Behind the first multilayer structure there is a layer of conducting optically transparent material 2, behind which there is a layer of material with low refraction index 7. Moreover, there is provided a second layer of conducting transparent material 2 and a second multilayer optical structure of alternating layers of materials with low and high refraction indexes. The thicknesses of alternating layers satisfy the same correlations as in the examples presented in FIGS. 8-9. The thickness of layer 7 is chosen with the condition that L=m*λ/(2*n), where m represents an even integer, λ represents the operating wavelength of the filter, and n represents the refraction index of layer 7. The thicknesses of layers in such filter are chosen with the condition to provide maximum transmission coefficient for the operating wavelength of the filter. The control voltage, applied to conducting layers 2, changes the refraction index of the material of layer 7, which leads to variation of the transmission band of the filter. The sequence of layers in the second multilayer optical structure is in reverse with that of the first one. Thus, FIG. 10 presents a filter with the following sequence of layers: H-L-H-L-H-E-2L-E-H-L-H-L-H, where H represents a layer with high refraction index, L a layer with low refraction index, and E an electrically conducting layer.

FIG. 11 presents an interferential optical filter different from the one presented in FIG. 10 by the placement of layers 2 of electrically conducting material. In general, layers of conducting material may be placed arbitrarily. It is essential that the electric fields created between them permeate the layers of electro-optical materials of the filter, changing their refraction indexes and controlling the optical characteristics of the filter.

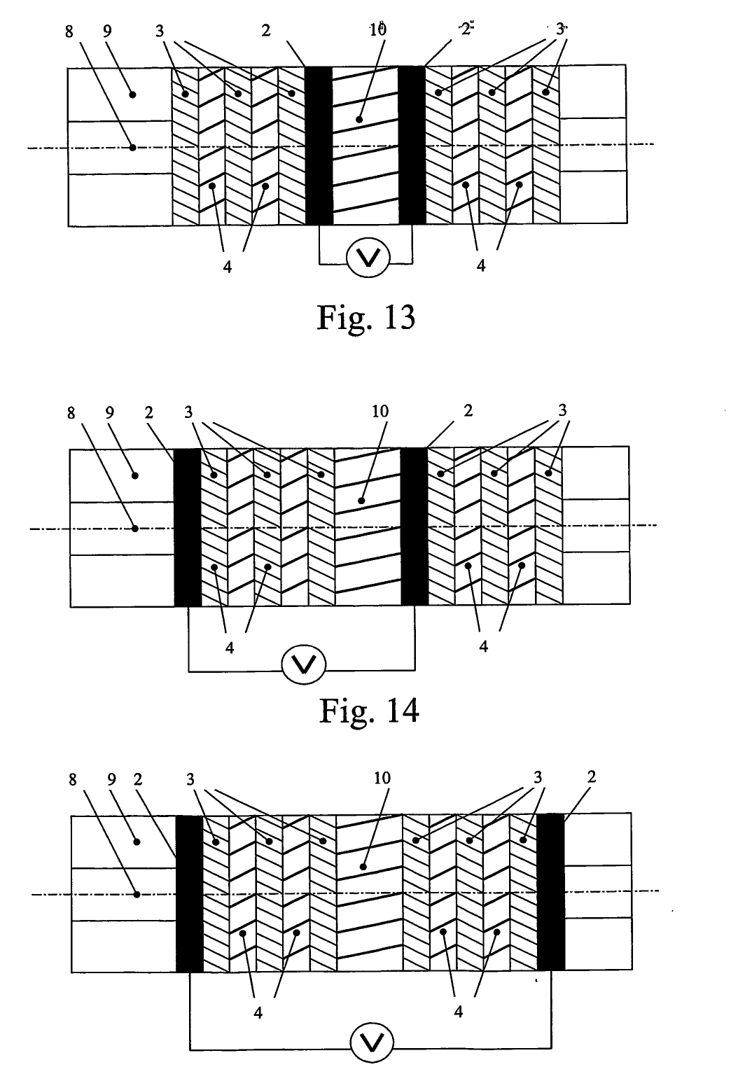

FIGS. 13, 14 and 15 present controllable interferential optical filters, differing from the filters presented in FIGS. 10, 11 and 12, by the sequence of layers: L-H-L-H-L-E-2H-E-L-H-L-H-L (FIG. 13), E-L-H-L-H-L-2H-E-L-H-L-H-L (FIG. 14) and E-L-H-L-H-L-2H-E-L-H-L-H-L (FIG. 15), where H represents a layer with high refraction index, L represents a layer with low refraction index, E—electrically conducting layer.

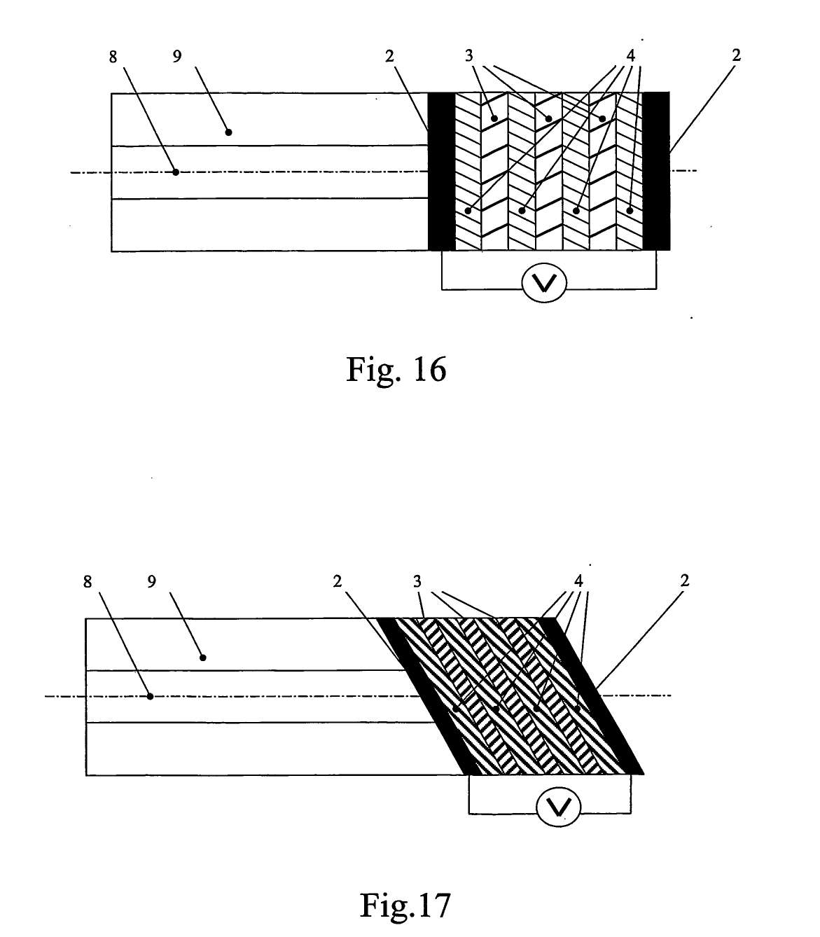

FIG. 16 presents a controllable interferential optical filter, comprising an optical fiber having core 8 and cladding 9, on the butt-end of which there are layers, which represent a multilayer optical structure of alternating layers with low 3 and high 4 refraction indexes. On both sides of the multilayer optical structure there are layers of conducting material 2. A control voltage is applied to these two conducting layers. The thicknesses of the alternating layers satisfy the following correlation L=m*λ/(4*n), where m represents an odd integer, λ represents the operating wavelength of the filter, and n represents the corresponding refraction index (n_{L} or n_{H}). Such filter features maximum reflection coefficient for the operating wavelength. The applied voltage onsets an electric field in the alternating layers, which changes the refraction indexes of the electro-optical materials utilized in these layers, and therefore leads to a change of the working wavelength of the filter for which it features maximum reflection coefficient.

FIG. 17 presents a controllable interferential optical filter, comprising an optical fiber having core 8 and cladding 9, on the slanted butt-end of which there are layers of interferential filters, which represent multilayer optical structures of alternating layers with low 3 and high 4 refraction indexes. In this case, the reflected wave is expelled from the optical fiber. On both sides of the multilayer optical structure there are layers of conducting material 2. The control voltage is applied to these two conducting layers. Such filter may be used at the output aperture of a laser or optical amplifier. Since the reflected wave does not return to the source of optical signal, such filter increases the stability of the optical systems against spontaneous excitation.

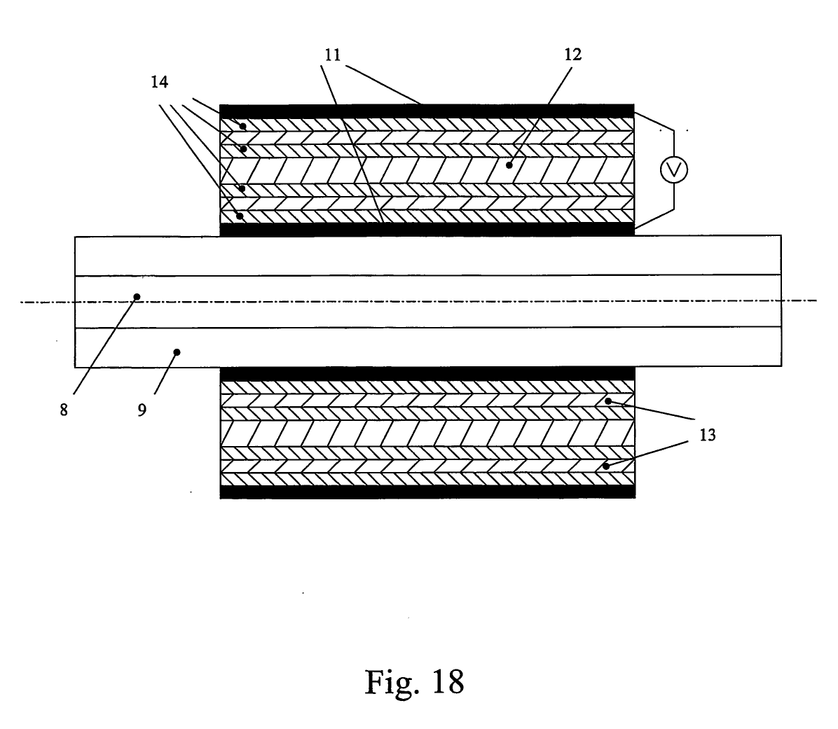

FIG. 18 presents a cross section of a controllable interferential optical filter comprising an optical fiber having core 8 and cladding 9, on the cladding of which there is a first cylindrical layer of conducting transparent material 11, which is coated with a first multilayer optical structure of alternating layers with low 13 and high 14 refraction indexes. The first multilayer structure is covered by an intermediate cylindrical layer of material with low refraction index 12. A second multilayer optical structure of alternating layers with low and high refraction indexes is formed on the intermediate layer 12. The second multilayer structure is in turn coated with a second conducting layer 11. The thickness of the alternating cylindrical layers satisfy the following correlation: L=m₁*λ/(4*n), where m₁ represents an odd integer, λ represents the operating wavelength of the filter, and n represents the corresponding refraction index (n_{L} or n_{H}). The thickness of layer 12 is chosen with the condition that L=m₂*λ/(2*n), where m₂ represents an even integer, λ operating wavelength of the filter, and n refraction index of layer 12. The thicknesses of the layers in such filter are chosen such as to provide maximum transmission coefficient for the operating wavelength of the filter. The control voltage applied to conducting layers 11 changes the refraction index of layer 12, which leads to variation of the transmission band of the filter. The sequence of layers in the second multilayer optical structure is reverse of that in the first one. Thus, FIG. 18 presents a filter with the following layer sequence: E-H-L-H-2L-H-L-H-E, where H represents a layer with high refraction index, L represents a layer with low refraction index, and E represents an electrically conducting layer. An operating voltage applied to the conducting layers shifts the transmission wavelength of the filter.

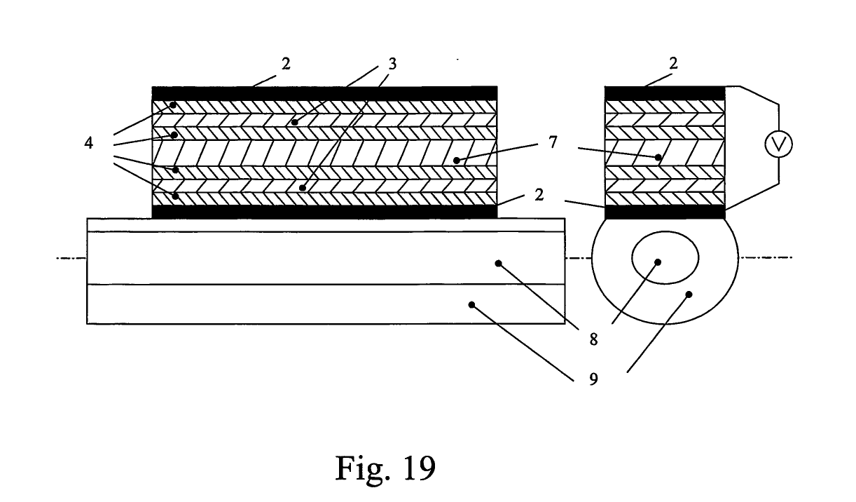

FIG. 19 presents a controllable interferential optical filter comprising a D-shaped optical fiber having core 8 and cladding 9, on the flat polished surface of the cladding of which there is a first layer of the conducting transparent material 2, on top of which there is a first multilayer optical structure of alternating layers with low 3 and high 4 refraction indexes. After the first multilayer structure there is an intermediate layer of material with low refraction index 7. Moreover, there is a second multilayer optical structure of alternating layers with low and high refraction indexes and a second layer of conducting transparent material 2. The thicknesses of the alternating cylindrical layers satisfy the following correlation L=m₁*λ/(4*n), where m₁ represents an odd integer, λ represents the operating wavelength of the filter, and n represents the corresponding refraction index (n_{L} or n_{H}). The thickness of layer 7 is chosen with the condition that L=m₂*λ/(2*n), where m₂ represents an even integer, λ represents the operating wavelength of the filter, and n represents the refraction index of layer 7. The thicknesses of the layers in such filter are chosen with the condition to provide maximum transmission coefficient for the operating wavelength of the filter. The control voltage applied to the conducting layers 2 changes the refraction index of layer 7, which leads to variation of the transmission band of the filter. The sequence of layers in the second multilayer optical structure is the inverse of that in the first one. Thus, FIG. 19 presents a filter with the following sequence of layers: E-H-L-H-2L-H-L-H-E, where H represents a layer with high refraction index, L represents a layer with low refraction index, and E represents an electrically conducting layer. The operating voltage applied to the conducting layers shifts the transmission wavelength of the filter. The operating voltage applied to the conducting layers shifts the transmission band of the filter.

In one embodiment, the interferential optical filter of the invention comprises at least one polarizer layer, and/or at least one phase-shifting layer, and/or at least one alignment layer, and/or at least one protective layer, and/or at least one mirror- or diffuse-reflecting layer, and/or at least one layer simultaneously functioning as any combination of at least two of the above layers. In another embodiment, the interferential optical filter contains at least one pair of electrodes which are under DC and/or AC voltage. The embodiment of an interferential optical filter is possible, in which at least a part of at least one of the electrodes is made form an optical non-transparent material, which has at least one transparent window to allow transmission of the light beam.

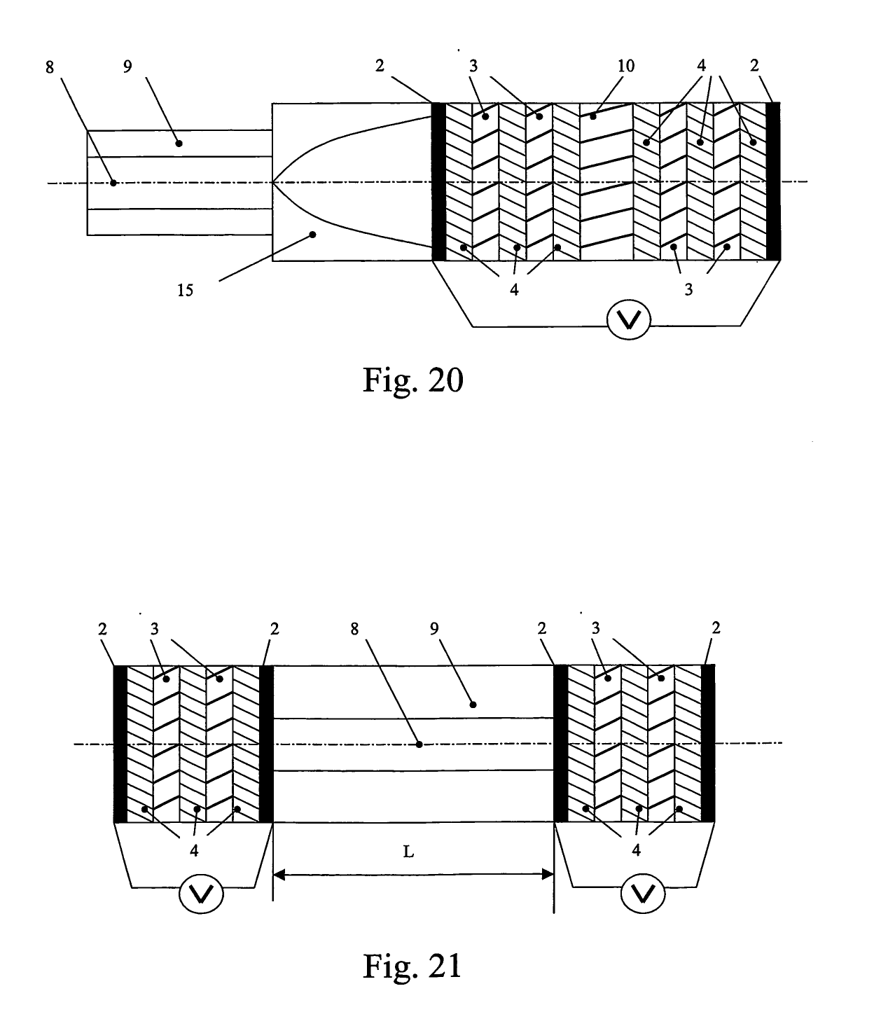

FIG. 20 presents a controllable optical device, comprising an optical fiber with core 8, cladding 9 and controllable interferential filters. Between the optical fiber and the filter there is a microlens 15. The microlens 15, for example with parabolic distribution of refraction index operates to broaden the light ray into a parallel light beam, which is necessary for better interaction with the interferential filters. The center of the lens 15 should be precisely placed coincidentally with the optical axis of the fiber. Usually, by moving the lens relative to the fiber, the position featuring the maximum transmission of the optical signal through the fiber and the lens can be determined and then the lens in that position to the fiber can be attached using epoxy glue. Mechanical clamps can also be used to fix the lens on the fiber. The controllable interferential filters in this optical device may be band transmitting as well as band reflecting. Besides that, the multilayer optical structure may be optimized so as to transmit light signals of only the upper or lower wavelength. The control voltage, in this case, controls the working wavelengths of the filter.

FIG. 21 presents a fiberoptic device, which comprises a segment of an optical fiber with length L, with core 8 and cladding 9 and two controllable interferential filters created on the opposite butt-ends of the optical fiber segment. These filters may be designed so that they operate as near perfect reflectors for the optical radiation in wide range of wavelengths. Such optical device may function as a Fabry-Perot interferometer, if one uses single-mode fiber. The optical path length of the core of such interferometer may be changed via various methods: bending the optical fiber, heating the fiber, affecting the fiber with acoustic wave, or via placing the fiber in magnetic or electric field. Therefore, one may modulate coherent light signal propagating through the filter. Besides that, when using multi-mode fiber optical signals of two or more waves, wavelengths λ₁, λ₂, . . . λ₁ may be spatially separated with such filter, in the same way as it is performed with a Fabry-Perot interferometer, due to the difference of optical paths of the mentioned optical signals. Analogous configuration can be used for the narrow bandwidth reflecting filter.

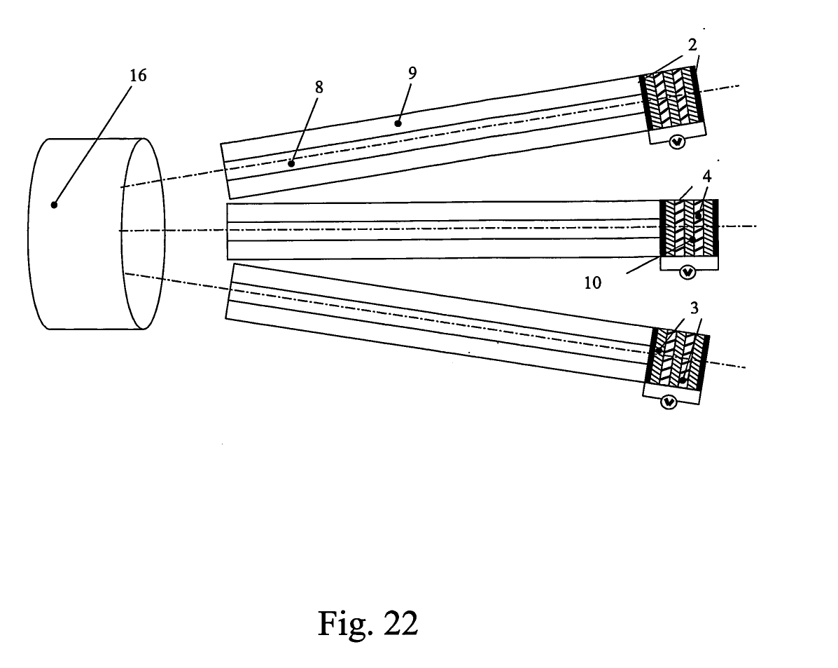

As illustrated in FIG. 22, the light source 16 may generate coherent or incoherent light signal. This light signal is incident on the system of several optical fibers. On the butt-end of each fiber there is a controllable interferential filter. Each filter is tuned to its individual wavelength, which may be changed by the electric field applied to the filter. Such device allows extracting optical signals of various individual colors out of a multi-wavelength source.

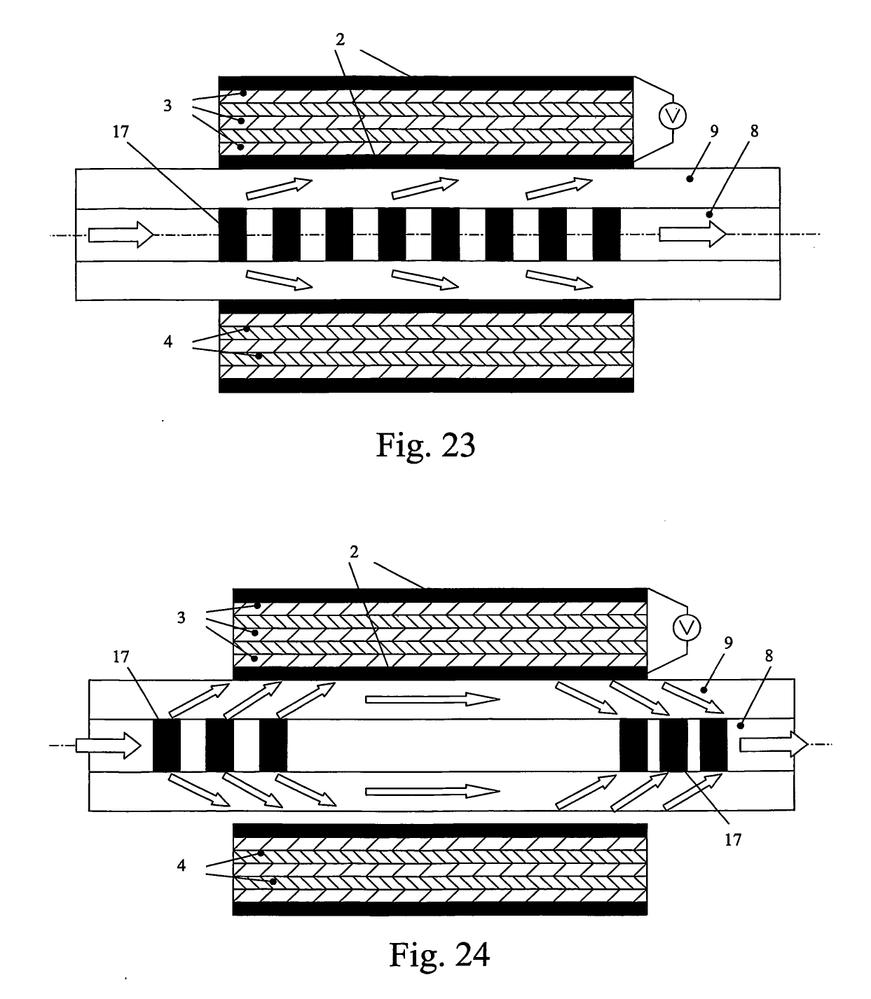

FIG. 23 presents a controllable interferential optical filter based on an optical fiber, in the core 8 of which there is a grating 17 with period of 100-600 μm. Such grating converts optical radiation, whose field is concentrated in the center of the core of the fiber and which is propagating in the fundamental mode or in any other mode guided by the core of the fiber, into one of the cladding modes, propagating in the cladding of the fiber. The grating may also function in reverse, i.e. convert radiation of the cladding modes into the fundamental mode or into any other mode guided in the core of the light guide. This grating provides effective communication between the core modes and the cladding modes due to phase synchronization. Therefore, such grating enhances interaction of light with the interferential filters formed on the surface of the cladding of the optical fiber. Since the thin crystal film features high optical anisotropy, this device is capable of selecting light modes with various polarizations. Besides that, since the thin crystal film features dependence of the absorption coefficient on the strength of electric field, such device allows modulation of light with certain wavelength via modulating absorption.

FIG. 24 illustrates an interferential optical filter, wherein there are two gratings 17, created in the core 8 of the optical fiber, and the active multilayer system of alternating layers 3 and 4 with electrodes 2 is created between them on the outside of the cladding 9. Here, the first grating extracts certain light modes and transfers them into the cladding, while the second grating transfers them back into the core. The active multilayer system of the filter affects light propagating through the core. Analogously to the previous example, this device allows modulating light of selected wavelength via adjusting absorption, since the thin crystal film features dependence of the absorption coefficient on the strength of electric field, or via adjusting the reflection coefficient of the filter via adjusting its transmission coefficient. Modulation of light depending on its polarization is also possible in this case, since the thin crystal film is anisotropic.

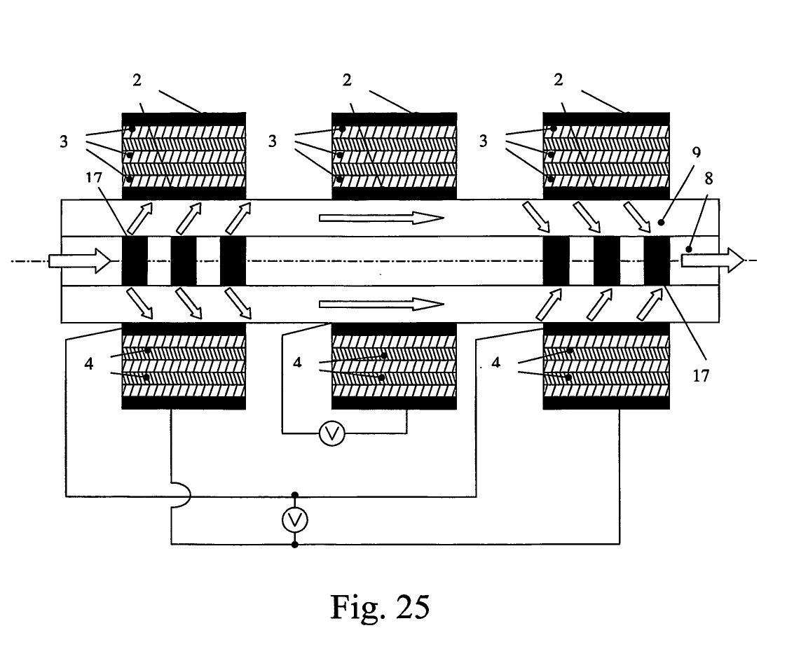

FIG. 25 illustrates a controllable electro-optical device, which represents a combination of the devices illustrated in FIGS. 23 and 24.

The following Table 1 summarizes the characteristics of the layers of a reflecting interferential optical filter, designed for 1550 nm wavelength. It is assumed that the beam of light is incident along the normal (along axis 0Z) onto layer 1. The main optical axes of the layer of anisotropic electro-optical material, which represents an anisotropic thin crystal film (TCF), are positioned along the 0X-axis (refraction index n=2.0) and along the 0Y-axis (refraction index n=1.6). Layers of optical materials of the filter are assumed to be flat and placed perpendicular to the 0Z-axis. Layers of ITO represent the electrodes, which are used to control optical characteristics of the filter.

TABLE 1
Characteristics of layers of the reflecting interferential
optical filter designed for 1550 nm wavelength.

| | | |
|---|---|---|
| Layer | Refraction index | Thickness, |

| number | Material | along 0X | along 0Y | nm |
|---|---|---|---|---|
| 1 | SₙO₂ | 2.0 | | 193.75 |
| 2 | ITO | 1.76 | | 220.17 |
| 3 | SₙO₂ | 2.0 | | 193.75 |
| 4 | TCF | 2.0 | 1.6 | 246.19 |
| 5 | SₙO₂ | 2.0 | | 193.75 |
| 6 | TCF | 2.0 | 1.6 | 246.19 |
| 7 | SₙO₂ | 2.0 | | 193.75 |
| 8 | TCF | 2.0 | 1.6 | 246.19 |
| 9 | SₙO₂ | 2.0 | | 193.75 |
| 10 | TCF | 2.0 | 1.6 | 246.19 |
| 11 | SₙO₂ | 2.0 | | 193.75 |
| 12 | TCF | 2.0 | 1.6 | 246.19 |
| 13 | SₙO₂ | 2.0 | | 193.75 |
| 14 | TCF | 2.0 | 1.6 | 246.19 |
| 15 | SₙO₂ | 2.0 | | 193.75 |
| 16 | TCF | 2.0 | 1.6 | 246.19 |
| 17 | SₙO₂ | 2.0 | | 193.75 |
| 18 | TCF | 2.0 | 1.6 | 246.19 |
| 19 | SₙO₂ | 2.0 | | 193.75 |
| 20 | TCF | 2.0 | 1.6 | 246.19 |
| 21 | SₙO₂ | 2.0 | | 193.75 |
| 22 | TCF | 2.0 | 1.6 | 246.19 |
| 23 | SₙO₂ | 2.0 | | 193.75 |
| 24 | ITO | 1.76 | | 220.17 |
| 25 | SₙO₂ | 2.0 | | 193.75 |
| 26 | Substrate | 1.46 | | 4000 |

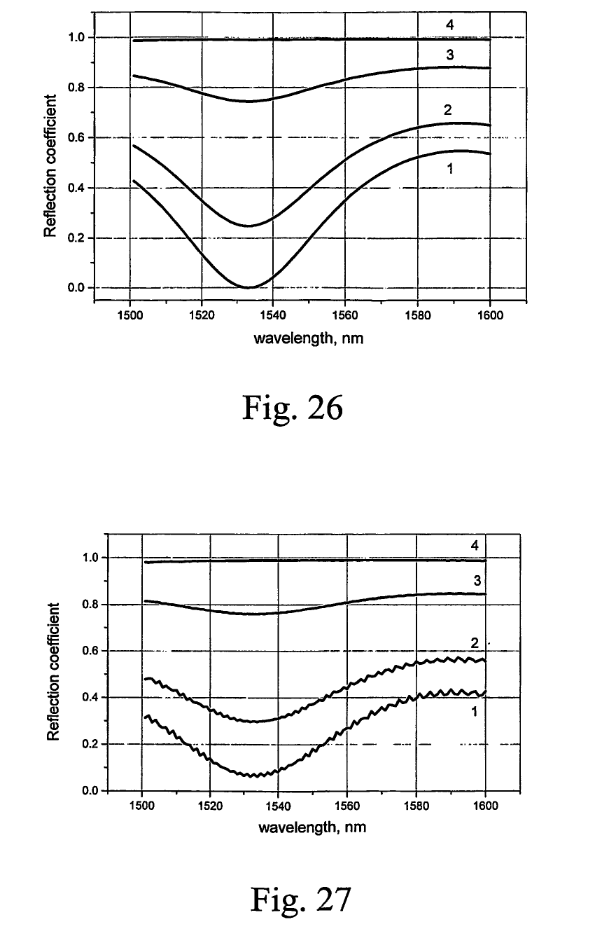

FIG. 26 illustrates the spectral characteristics of the reflection coefficient of the multilayer system without correction for the substrate at normal incidence of linearly polarized light. Curves illustrated in FIG. 26 correspond to the various angular orientation φ of the polarization vector relative to the x-axis: 1) φ=0°; 2) φ=30°; 3) φ=60°; 4) φ=90°;

According to FIG. 26, light which is polarized along the y-axis (curve 4) is completely reflected by the multilayer system. The reflection coefficient (curve 1) for light polarized along the x-axis depends on the wavelength, and at wavelength λ=1533 nm reaches its minimum value equal to 3×10⁻⁵. Thus, transmission coefficient for this wavelength is close to unity. These data demonstrate that the multilayer system behaves as a polarizer.

The substrate influences the spectrum of the reflected light and decreases its maximum degree of polarization, as shown in FIG. 27. FIG. 27 presents the dependence of the reflection coefficient on the wavelength for linearly polarized light in the presence of the substrate having a thickness of 4 mm. The curves illustrated in FIG. 27 correspond to different angular orientation of the vector of polarization relative to the x-axis: 1) φ=0°; 2) φ=30°; 3) φ=60°; 4) φ=90°; the inverse coherence length of spectral components used in calculations is −Δλ/λ²=0.002 μm⁻¹.

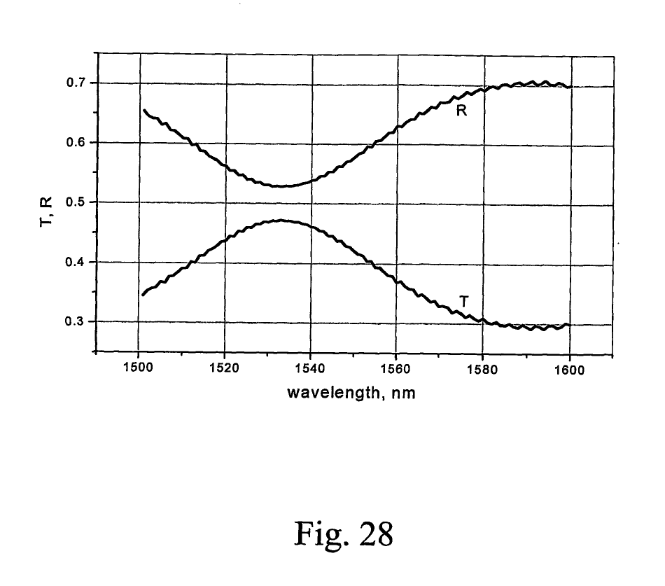

FIG. 28 illustrates transmission and reflection coefficients depending on the wavelength in the case of using unpolarized light in the presence of a substrate having a thickness of 4 mm. Obviously, the transmitted light is linearly polarized along the x-axis in the entire spectral range and has a degree of polarization above 0.94. For wavelength λ=1533 nm, the transmission coefficient is above 0.45, which is remarkable. Even in the worst cases (for example at λ=1580-1600 nm), the transmission coefficient is above 0.3, and the degree of polarization is approximately 0.94. The reflected light is linearly polarized along the y-axis (degree of polarization reached 0.87 for λ=1533 nm and decreases to the minimum value of 0.4 for λ=1600 nm).

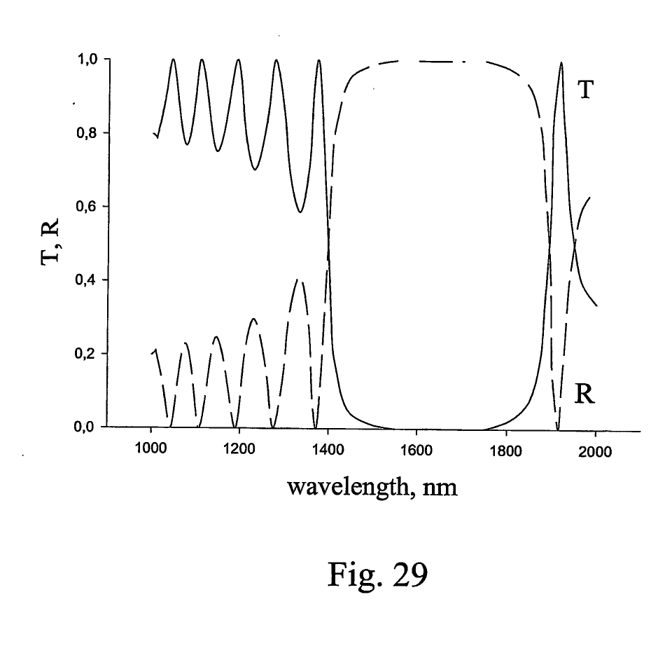

A simplified configuration of the multilayer system is provided to explain the physical mechanism of the phenomenon without intention to limit the scope of the invention in any way. A multilayer system comprising 21 layers is considered: (1)<PI>(2)<TCF>(3)<PI>(4)<TCF> . . . (19)<PI>(20)<TCF>(21)<PI>. The thickness of each layer is about 0.2 μm, so that the total thickness of the multilayer system is about 4.2 μm. <PI> denotes optical anisotropic layer of polyimide with refraction index of 1.6 and corresponds to the lower value of the refraction index of TCF. To enhance the effect, it is assumed that the higher value of the refraction index of TCF is 2.4. Then, along the x-axis there is spatial modulation of the refraction index with a period of 0.4 μm, while along the y-axis the medium is homogeneous. The spectra of the transmitted and reflected signals of this system for x-polarized light are shown in FIG. 29. Within the range of wavelengths from 1400 to 1900 nm there is a band of 100% reflection. This effect is similar to the one observed with cholesteric liquid crystals, which are characterized by the range of selective reflection coefficient, determined by the pitch of its spiral. The difference is that in case of cholesterics, the reflected light has circular polarization, while in the present invention, the reflected light has linear polarization.

Analogously to the case with cholesterics, the width of range of the selective reflection coefficient allows for the following to be true:

$$\frac{Δλ}{{λ}_{m}} ≅ \frac{Δ n}{ n}$$

$$\frac{1900 nm - 1400 nm}{1650 nm} ≅ \frac{2.4 - 1.6}{2.4} ≅ 0.33$$

where Δn=n_{x,TCF}−n_{x,PI}=2.4−1.6=0.8, λₘ means wavelength of the range of selective reflection coefficient.

Since the medium is homogeneous along the y-direction, the y-polarized light is completely transmitted by this system, while the x-polarized light is reflected by the interferential filters, when the wavelength is within the range of the selective reflection coefficient. Increasing the number of layers makes the spectral dependence of the reflection coefficient flat within the range of the selective reflection coefficient, and the value of the reflection coefficient itself becomes very close to unity.

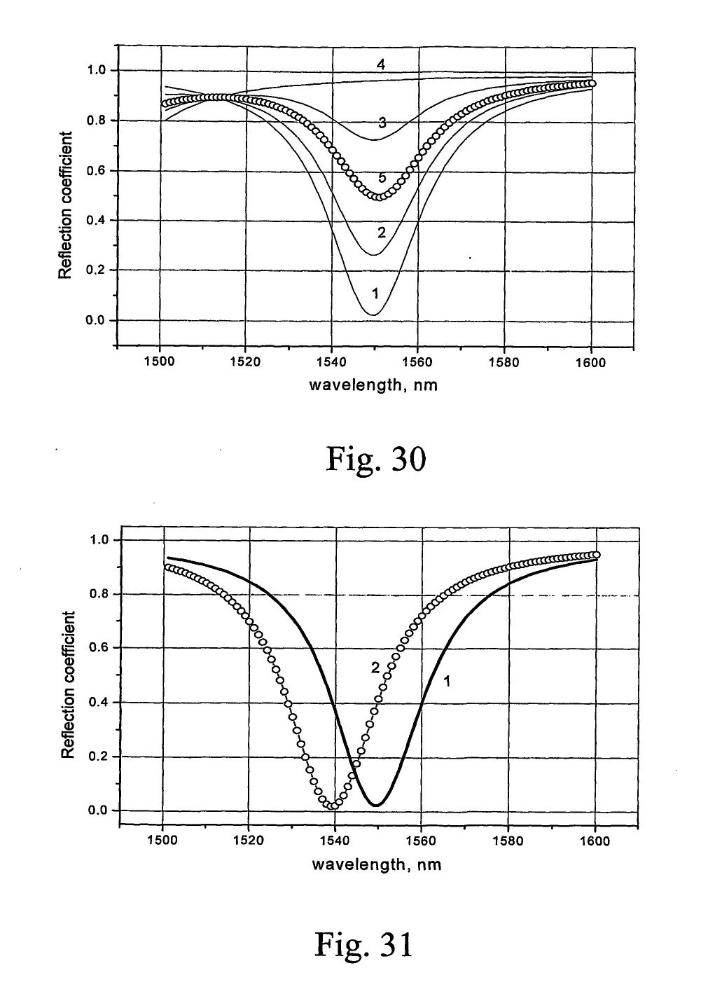

Table 2 presents the characteristics of the layers of a band-transmitting optical filter, designed also for λ=1550 nm. Analogously to the previous case, it is assumed that the beam of light is incident along the normal (along the axis 0Z) onto layer 1. The main optical axes of the anisotropic thin crystal film are along the 0X-axis (n=2.0) and the 0Y-axis (n=1.6), the rest of the layers are anisotropic. Layers of ITO represent electrodes, through which optical characteristics of the filter are controlled. Layers of optical materials of the filter are assumed to be flat and placed perpendicularly to the 0Z-axis. Dependences of the reflection coefficients of this optical structure on the wavelength calculated for the range of wavelengths between 1500 and 1600 nm and for four cases of polarization of the incident light, are presented in FIGS. 30 and 31. Since the field vector lays in the plane X0Y, FIGS. 30-31 illustrate the following cases of polarization: φ0°, 30°, 60° and 90°, where φ represents the angle between the 0X-axis and the electric field vector of the light wave.

TABLE 2
Characteristics of layers of the band-transmitting
optical filter designed for 1550 nm wavelength

Refraction index

| Layer | | Along the | Along the | Thickness, |
|---|---|---|---|---|
| number | Material | 0X-axis | 0Y-axis | nm |
| 1 | TiO₂ | 2.3 | | 168.48 |
| 2 | SiO₂ | 1.43 | | 270.98 |
| 3 | TiO₂ | 2.3 | | 168.48 |
| 4 | SiO₂ | 1.43 | | 270.98 |
| 5 | TiO₂ | 2.3 | | 168.48 |
| 6 | ITO | 1.76 | | 220.17 |
| 7 | TCF | 2.0 | 1.6 | 387.5 |
| 8 | ITO | 1.76 | | 220.17 |
| 9 | TiO₂ | 2.3 | | 168.48 |
| 10 | SiO₂ | 1.43 | | 270.98 |
| 11 | TiO₂ | 2.3 | | 168.48 |
| 12 | SiO₂ | 1.43 | | 270.98 |
| 13 | TiO₂ | 2.3 | | 168.48 |

The filter described in Table 2 is characterized by distinct selective range of wavelengths for the light polarized along the x-axis as shown in FIG. 30. The curves (1-4) in FIG. 30 correspond to the different angular orientation φ of polarization relative to the x-axis: 1) φ=0°; 2) φ=30°; 3) φ=60°; 4) φ=90°. Curve 5 corresponds to the unpolarized light. The lowest value of the reflection coefficient is approximately equal to 3% for wavelength 1550 nm. For the orthogonal polarization, reflection coefficient is approximately 95%. Thus, the filter behaves as a good polarizer for the wavelength equal to 1550 nm. The degree of polarization for the wavelength 1555 nm is equal to 0.93.

Since refraction index of the anisotropic thin crystal film (TCF) is sensitive to the strength of the electric field, the working range of the filter described in Table 2 can be controlled. FIG. 31 demonstrates the change of the spectrum, when x-component of the refraction index of the anisotropic thin crystal film changes from 2 (curve 1) to 1.95 (curve 2). It is clear that the spectral characteristics of the optical interferential filter are controlled by the electric field.

EXAMPLE: Fabrication Of Electro-Optical Anisotropic Thin Crystal Film From Lyotropic Liquid Crystal (LLC) Of Sulfonated Indanthrone

The fabrication of electrodes and layers of anisotropic materials of the interferential optical filter was performed using standard fabrication techniques. Therefore, the description on fabrication of the substrate, electrodes and anisotropic layers is omitted. One major significance in the disclosed invention was the method of fabricating the anisotropic thin crystal film.

The method of fabricating anisotropic thin crystal film used 9.5% aqueous solution of sulfonated indanthrone, which formed hexagonal phase at room temperature. In a solution, the molecules of this organic dye aggregated into anisometric supramolecular complexes. These complexes functioned as the foundation for the crystalline structure of the film. The original ink after purification was applied onto a Si-glass substrate using direct pouring and smearing. Then the viscosity of the colloid system was decreased by some kind of external influence, which was necessary for performing the subsequent alignment. At this time, solution formed a nematic phase or a mixture of nematic and hexagonal phases. The viscosity of the system decreased from 1780 mPa/sec to 250 mPa/sec. Only under the condition of decreasing the viscosity of the system, anisotropic thin crystal films with good quality can be obtained.

The next operation was the process of aligning kinetic units of the colloid system of LLC. Various aligning tools could be used to perform this operation. In this example, a aligning cylindrical Mayer rod 4 having a diameter of 9.5 mm and wound with a wire was used. The diameter of the rod determined the thickness of the wet layer. While performing the aligning influence, the rod was moving at 13 mm/sec. Shearing stresses due to the movement of the rod led to an additional decrease of viscosity of the system.

The next operation was the drying process. Requirements to this process were such that the rate of removal of the solvent should be slow in order to prevent damaging the earlier aligned structure. In this example, drying was performed at the room temperature and 60% humidity.

Resulting from the above fabrication technique were anisotropic thin crystal films with a thickness of 0.3-0.4 μm, with high degree of anisotropy of optical and electrical properties, featuring good reproducibility of parameters over the area of the films as well as from one batch to another. Perfection of the crystalline structure of the obtained films was evaluated by optical x-ray diffraction methods.

The foregoing descriptions of specific embodiments of the invention have been presented for the purpose of illustration and description. They are not intended to be exhaustive or to limit the invention to the precise forms disclosed, and obviously many modifications, embodiments, and variations are possible in light of the above teaching. It is intended that the scope of the invention be defined by the claims appended hereto and their equivalents.

What is claimed is:

1. An interferential optical filter, comprising multiple layers each having real and/or imaginary refraction indexes, the values of which depend on the strength of an external electric field,
wherein the refraction indexes and the thickness of each layer and their combination are selected such as to provide an interference extremum in at least one region of the spectrum for at least one polarization of incident light, and
at least one layer is made of an electro-optical material, said electro-optical material is anisotropic and made from at least one aromatic organic material, molecules or fragments of molecules of which have a flat structure, and at least part of said at least one layer has a crystalline structure with an intermolecular spacing of 3.4±0.2 Å along one of optical axes.

2. The interferential optical filter according to claim 1, wherein at least one layer of the anisotropic electro-optical material is treated with ions of two- and three-valence metals.

3. The interferential optical filter according to any of claims 1 or 2, wherein the molecules of the at least one aromatic organic material contain heterocycles.

4. The interferential optical filter according to any of claims 1 to 3, wherein at least one layer of the anisotropic electro-optical material is made of lyotropic liquid crystal based on at least one dichroic dye.

5. The interferential optical filter according to any of claims 1 to 4, wherein at least one layer of the anisotropic electro-optical material is characterized by the imaginary (K₁, K₂, K₃) and real (n₁, n₂, n₃) parts of the complex refraction index, which satisfy the following correlations:
K₁≧K₂≧K₃, and
(n₁+n₂)/2>n₃.

6. The interferential optical filter according to any of claims 1 to 5, wherein the layers of the interferential filters are flat.

7. The interferential optical filter according to any of claims 1 to 5, wherein the layers of the interferential filters have shapes of the second order.

8. The interferential optical filter according to any of claims 1 to 7, further comprising at least one diffuse- or mirror reflecting substrate, or a substrate made of an optically transparent material.

9. The interferential optical filter according to claim 8, wherein the substrate is made of glass and/or quartz, and/or polymeric semiconductor, which is crystalline or amorphous.

10. The interferential optical filter according to any of claims 1 to 5, wherein a sidewall surface of at least one planar or cylindrical optical waveguide is used as a substrate for the filter.

11. The interferential optical filter according to any of claims 1 to 6, wherein at least one butt-end surface of at least one optical waveguide is used as a substrate for the filter.

12. The interferential optical filter according to any of claims 10 to 11, wherein at least one optical waveguide is a single-mode.

13. The interferential optical filter according to any of claims 10 to 11, wherein at least one optical waveguide is a multi-mode.

14. The interferential optical filter according to any of claims 10 to 13, wherein at least one optical waveguide contains at least one core and one or more claddings, which have refraction indexes less than the refraction index of the at least one core.

15. The interferential optical filter according to any of claims 1 to 6, wherein a flat side-surface of at least one optical D-shaped waveguide is used as a substrate for the filter.

16. The interferential optical filter according to any of claims 1 to 6 or 12 to 15, wherein the filter is formed on at least one butt-end of at least one optical waveguide, which is slanted at an angle from 0 to 90 degrees relative to the axis of the waveguide.

17. The interferential optical filter according to any of claims 1 to 16, further comprising at least one polarizing layer, and/or at least one phase-shifting layer, and/or at least one alignment layer, and/or at least one protective layer, and/or at least one mirror- or diffuse-reflecting layer, and/or at least one layer simultaneously functioning as any combination of at least two of the said layers.

18. The interferential optical filter according to any of claims 1 to 18, further comprising at least one pair of electrodes, which are under DC and/or AC voltage.

19. The interferential optical filter according to claim 18, wherein at least a part of at least one of the electrodes is made of an optical transparent material.

20. The interferential optical filter according to any of claims 18 to 19, wherein at least a part of at least one of the electrodes is made of an optical non-transparent material, which has at least one window transparent to light beam.

21. The interferential optical filter according to any of claims 18 to 20, wherein at least one pair of electrodes is situated on opposite surfaces of at least one layer of electro-optical material.

22. The interferential optical filter according to any of claims 18 to 21, wherein at least one pair of electrodes is situated on one surface of at least one layer of electro-optical material.

23. The interferential optical filter according to any of claims 18 to 22, wherein at least one pair of electrodes is situated on at least one butt-end of at least one layer of electro-optical material.

24. The interferential optical filter according to any of claims 18 to 23, wherein at least one pair of electrodes is situated on the different butt-ends of at least one layer of electro-optical material.

25. The interferential optical filter according to any of claims 18 to 24, wherein at least one layer of electro-optical material does not have electrical contact with at least one electrode, which belongs to at least one pair of electrodes, and voltage applied to this pair of electrodes creates electric field in said layer of electro-optical material.

26. The interferential optical filter according to any of claims 14 to 25, wherein at least one core of said optical waveguide further comprises at least one grating.

27. The interferential optical filter according to claim 26, which is formed on at least a part of the cladding of said optical waveguide and at least partially overlapping with at least one region of the core that comprises at least one grating.
